(19) United States
(12) Patent Application Publication
(10) Pub. No.: US 2006/0250978 A1
(43) Pub. Date: Nov. 9, 2006

(54) Personal communication interaction manager

(75) Inventor: Christopher Stanley Lawrence, Worcester, MA (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: CIM, Ltd. c/o Golden Gate Private Equity, Inc., San Francisco, CA (US)

(21) Appl. No.: 11/122,732

(22) Filed: May 5, 2005

(51) Int. Cl. H04L 1/00

(52) U.S. Cl. 370/252; 370/401

(57) ABSTRACT

A system and method for providing communications between a communication center and a user are disclosed. The exemplary method transmits identification information of the user from a communication device of the user to the communication center. The communication center identifies a transaction record associated with the user and transmits the user's transaction record to the user. The communication center also transmits current status information for a plurality of queues to the user. The transaction record of the user and the current status information for a plurality of queues are presented to the user.

### TECHNICAL FIELD

The present invention relates to a method and system for providing communications between a communication center and a user, and more particularly relates to providing additional information and options to a user of a communication center.

### BACKGROUND INFORMATION

Communication centers allow a user to purchase and obtain customer support for products and services. Agents staff the communication center and provide sales or support information on various products and services. A user may place a communication to the communication center through a variety of modes of communication; for example, the user may place a telephone call or email to the communication center. An Automatic Call Distributor (ACD) or communication management server of the communication center receives the telephone call or email and routes the communication to an agent. The agents of a communication center may also initiate communications. For example, the communication center may place a telephone call to a user. The communication center then contacts an available agent when the user answers the telephone and connects the agent to the user.

Communication centers are under pressure to minimize costs while providing answers to user's questions in a convenient manner. Complex questions may necessitate multiple communication sessions with a communication center to resolve the user's issue. For example, a user may request information or a service that the agent cannot immediately satisfy. In that case, the agent may record the communication so that the agent or a more qualified agent may follow up and satisfy the user's request. The agent can record an audio segment of the conversation between the user and the agent and store the audio segment into a transaction record of the user. The agent may also enter text notes into the transaction record of the user. An agent of the communication center may then access the transaction record of the user at a later time to better respond to the previous user's request or a new request by the user.

Communication centers do not receive user requests for information in regular intervals. During peak periods of user requests, the communication center may have to place the user on hold in a queue of the communication center until an agent currently handling other requests is available to respond to the user on hold. During periods of reduced user requests, the communication center must deal with the increased cost of agents sitting idle. The communication centers have to balance the cost of overstaffing with the reduced convenience to users that must be placed on hold.

To help alleviate the irregular patterns of user requests, communication centers have provided users with information associated with the current wait time of user requests waiting in a queue of the call center. However, this does not always provide the user with adequate information. Based on the foregoing, it is apparent that there is a need for a system and method to provide a user with additional information to aid in the user placing a request to the communication center. It is apparent that there is also a need to correctly provide documentation of a transaction in a transaction record of the user in an efficient manner.

### SUMMARY

The present invention is a novel system and method for providing communications between a communication center and a user. The method transmits identification information of the user from a communication device of the user to the communication center. The communication center identifies a transaction record associated with the user and transmits a portion of the transaction record of the user to the user and the current status information for a plurality of queues to the user.

In an alternative embodiment, the method transmits one or more prior queue status information. In another embodiment, the prior queue status information may include average wait times throughout the previous day. In another embodiment, the current status information may include the number of agents assigned to each queue. In another exemplary embodiment the method also provides the user with links to one or more modes of communication. In yet another exemplary embodiment the method transmits current transactions of the user. For example, the current transactions may include comments entered by the agent. The method may transmit comments entered by the user to the agent and store the comments entered by the user in the transaction record associated with the user.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a system diagram of a communication network used to provide a personal communication interaction manager system.

FIG. 2 is a flow chart illustrating a first exemplary embodiment of the invention.

FIG. 3 is a flow chart illustrating a second exemplary embodiment of the invention.

FIG. 4 is a flow chart illustrating a third exemplary embodiment of the invention.

### DETAILED DESCRIPTION

The system and method of the personal communication manager provides a user with additional information to aid the user in placing or receiving a communication to or from the communication center. A communication may be a variety of forms of communication, for example, but not limited to, a phone call, an email, a chat session, or a video call or mail. The communication manager provides users with additional information to help the user efficiently place a communication to the communication center. The communication manager also helps the user obtain the desired information or action and make efficient use of the communication center's resources.

The communication manager may provide the user with information regarding the current or past status of one or more queues of incoming communications for the communication center. The communication manager may also provide the user with access to a transaction record associated with the user. The user can use this information to decide the best agent or group of agents to contact regarding the user's desired information. The user can also determine the most suitable mode of communication and the most suitable time to place a communication to the communication center.

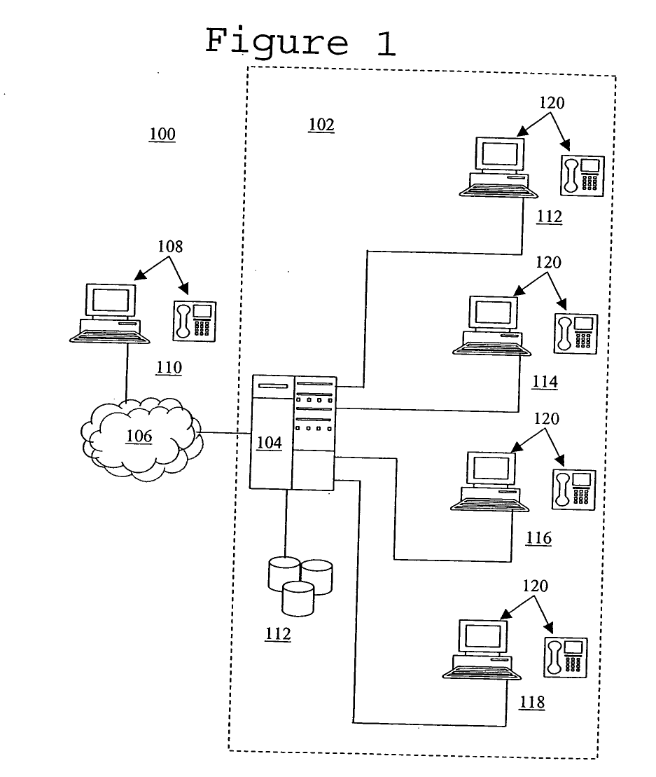

FIG. 1 is an exemplary system diagram of a communication network 100 used to provide the personal communication interaction manager method and system. The communication center 102 has one or more trunk lines that connect an Automatic Call Distributor (ACD) or communication management server 104 to a communication network 106. The communication network 106 provides a communication link to a communication device 108 of a user 110. The user communication device 108 may be a variety of devices used to send and receive audio and visual communications to the user 110. Examples of the user communication device 108 include but are not limited to a telephone, a videophone, a computer for sending email or text messages or other communication devices. The user communication device 108 receives information from the user and transmits the information over the communications network 106. The user communication device 108 also may receive information from the communication network 106 and present it to the user in the form of an audible or visual message. The communication network 106 may be a variety of networks using a variety of protocols, for example, but not limited to, a Public Switched Telephone Network (PSTN), an Internet Protocol (IP) network using Hypertext Markup Language (HTML) or Internet Protocol Network Telephony (IPNT) or a combination of networks and protocols. The user communication device 108 organizes the information into the format of the desired communication network 106 and transmits the information to the call center 102.

The communication management server 104 routes communications from the communication network 106 to agents of the communication center. In the exemplary communication network 100, the communication center 102 has four agents (a first agent 112, a second agent 114, a third agent 116, and a forth agent 118) to handle communications sent and received by the communication center 102. An agent communication device 120 is provided to each agent of the communication center. The agent communication device 120 may be a variety of devices used to send and receive audio and visual communications to the user as well as communications with other agents and the communication management server 104. Examples of the agent communication devices 108 may include but are not limited to a telephone, a videophone, a computer or other communication devices. The agents of the call center respond to communications placed to the communication center 102 by users 110. The agents 112, 114, 116, and 118 may provide the user with the desired information or the desired action of the user.

For example, a user may want to book a Caribbean cruise. The user places a telephone call to the communication center. An automated prompting system of the communication management server 104 may identify that the user wishes to book a Caribbean cruise. The communication manager server 102 routes the telephone call to the agent responsible for handling Caribbean cruise bookings. In this example, the second agent may be the agent authorized to book Caribbean cruises. The communication management server 104 routes the call to the second agent 114. The second agent 114 answers the calls and books the cruise for the user.

During peak periods of user communication requests, the communication center may have to place communications of a user on hold in a queue of the call center until an agent is available to respond to the communication request. The communication may be placed in a hold queue along with additional communications as additional communications from other users are received by the communication center 102. As agents become available to respond to communications, the communication management server 104 removes the communication from the queue and routes the communication to the available agent. The communication center 102 may have multiple queues for various groups of agents and modes of communication. For example, the communication center may have a queue for telephone communications and a queue for email communications. In another example, the communication center 102 may have a queue for various groups of agents. One queue may be for communications regarding sales and another queue may be for communications regarding technical product support.

During the process of receiving and responding to communications, the communication center 102 may want to document the communications handled by agents of the communication center 102. The communication management server 104 may have a data storage device 112 for storing information associated with handling and processing communications by the communication center 102. The communication management server 104 or agent may create a transaction record for each communication received or sent by the communication center 102. The transaction record may include a variety of information associated with the communication. For example, the record may include the user's name, the user's phone number, the reason that the user placed the communication, notes by the agent handling the communication, and actions taken based on the user's communication. The transaction record may also include audio segments of the communication or other recorded segments of the communication between the agent and user. These transaction records may be grouped and associated with a single transaction record of a user.

In one example, a user may have a complex request that an agent may be unable to handle in one communication. For example, a user places a communication requesting a correction of a bank account record. The agent handling the communication may not be authorized to edit the account without requesting an examination of the correction. A transaction record is produced identifying the user's request, the agent handling the communication, and actions and notes as a result of the request. Once the examination of the correction is completed, the agent may use the transaction record to refresh the agent's memory or another agent may use the record to review the request before contacting the user regarding the results of the examination.

The personal communication manager system and method may also provide the user 110 with access to some or all of the transaction record. The user 110 may download the current version of the transaction record to a computer associated with the user communication device 108. The user 110 may now see information with regard to the user's previous and current communications. The user 110 may use this information to determine which agent 112, 114, 116, 118 or group of agents to contact.

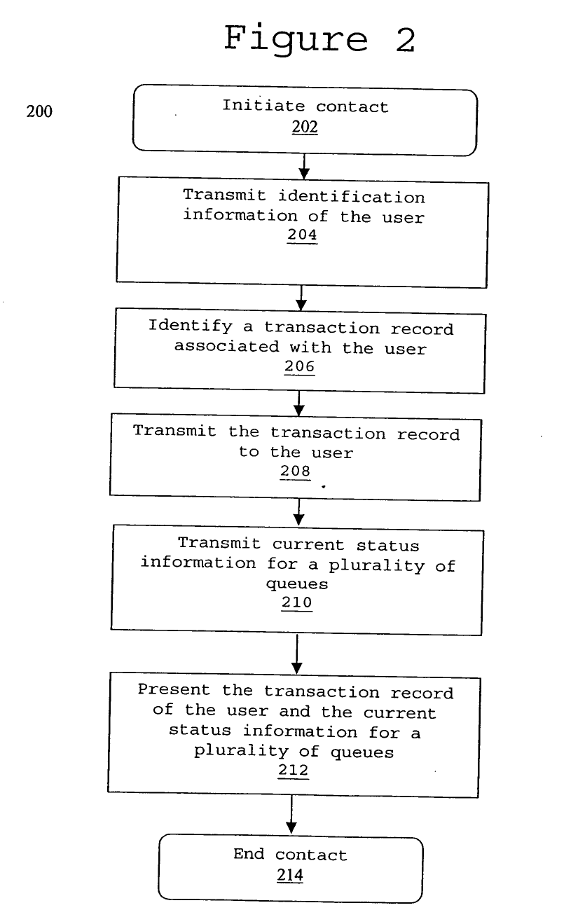

A flow chart illustrating a first exemplary embodiment of the invention is shown in FIG. 2. The first exemplary embodiment 100 allows the user 110 to access transactions records and/or the status of communication center queues 112. The user 110 can use this information to decide the agent 112, 114, 116, 118 to best handle the user's communication. The user 110 may also use this information to decide the best time to send a communication and best mode of communication to transmit the communication. The method of the first exemplary embodiment 200 begins when the user 110 decides to initiate a communication (block 202) to the communication center 102. This may occur when the user 110 begins to transmit a communication or when the user 110 attempts to gather information to transmit a communication.

The user 110 transmits identification information of the user 110 to the communication center 102 (block 204). This can be accomplished by the user 110 logging onto a website, for example, or by the user 110 placing a telephone call to the communication center 102 and entering a personal identification number (PIN) or other information to identify and/or verify the user's identity. The communication management server 104 receives the identification information from the user 110 and identifies a transaction record associated with the user 110 (block 206). As previously discussed, the transaction record may include information associated with prior or current transactions between the user 110 and the communication center 102. The communication management server 104 may transmit all or a portion of the information in the transaction record (block 208).

For example, the user 110 may be provided with information associated with the last transaction. This information may include the agent that handled the last transaction and a list of agents that may be associated with that agent and can handle inquiries regarding that transaction. The communication management server 104 may also transmit the current status information for a plurality of queues available to the user 110 (block 210). The status information may be associated with the various agents available to the user 110 or various modes of communication available to the user 110.

The transaction record of the user 110 and the current status information for a plurality of queues is presented to the user 110 (block 212). This may be in the form of an audio prompt or a graphical display. In one example of the first exemplary embodiment, the communication management server 104 may transmit the name of the agent that handled a pending transaction. The communication management server 104 may also transmit the name of available agents that work in the same group as the agent that handled the pending transaction. The communication management server 104 may even transmit the name of the supervisor of the group of agents. The communication management server 104 may also transmit the estimated wait time associated with each of the agents that handled the prior communication, the group of agents that may handle inquiries to the prior communication, and the supervisors associated with the group of agents. The user 110 can use this information to determine the best agent to handle the current communication and then place the communication to the agent. The communication management server 104 may provide the user 110 with updates to the transaction record and queues while the user 110 makes the communication. Once the user 110 completes the communication, the process is completed (block 214).

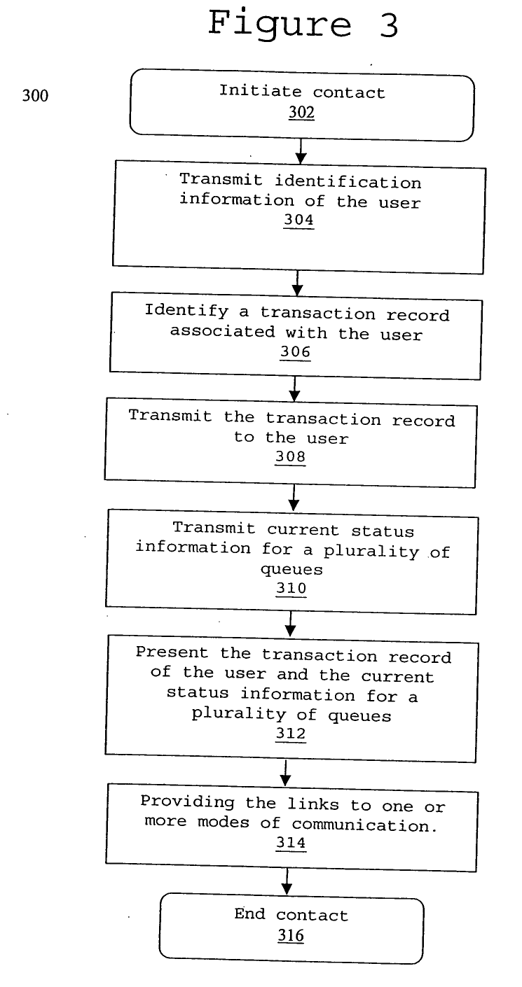

A flow chart illustrating a second exemplary embodiment 300 of the invention is shown in FIG. 3. The second exemplary embodiment 300 provides the user 110 with links to place a communication to the communication center 102. The method of the second exemplary embodiment 300 begins when the user 110 decides to initiate a communication to the communication center 102 (block 302), as previously discussed in the first exemplary embodiment 200. The user 110 transmits identification information of the user 110 to the communication center 102 (block 304). The communication management server 104 receives the identification information from the user 110 and identifies a transaction record associated with the user 110 (block 306). The communication management server 104 may transmit all or a portion of the information in the transaction record (block 308). The communication management server 104 may also transmit the current status information for a plurality of queues available to the user 110 (block 310). The transaction record of the user 110 and the current status information for a plurality of queues is presented to the user 110 (block 312). The above aspects of the second exemplary embodiment 300 are similar to the first exemplary embodiment 200 and are previously described in greater detail in the discussion of the first exemplary embodiment 200.

The second exemplary embodiment 300 may provide the user 110 with links to one or more modes of communication (block 314). Based on the transaction record, the communication management server 104 may determine the agents, the group of agents, or modes of communication currently available to the user 110. Along with providing information associated with queues for each, the communication management server 104 may also provide a convenient link so that the user 110 may place a communication to the agent or group of agents. For example, the communication management server 104 may transmit and display information associated with contacting a specific agent and a group of agents along with estimated wait times for telephone calls and email for both. The communication management server 104 may also provide a link for the user 110 to establish the communication. When the user 110 selects the link, a communication is sent to the communication center 102. For example, the user 110 may select a link that allows the user 110 to enter an email request and send it to the agents selected by the user 110. Once the user 110 completes the communication, the process is completed (block 316).

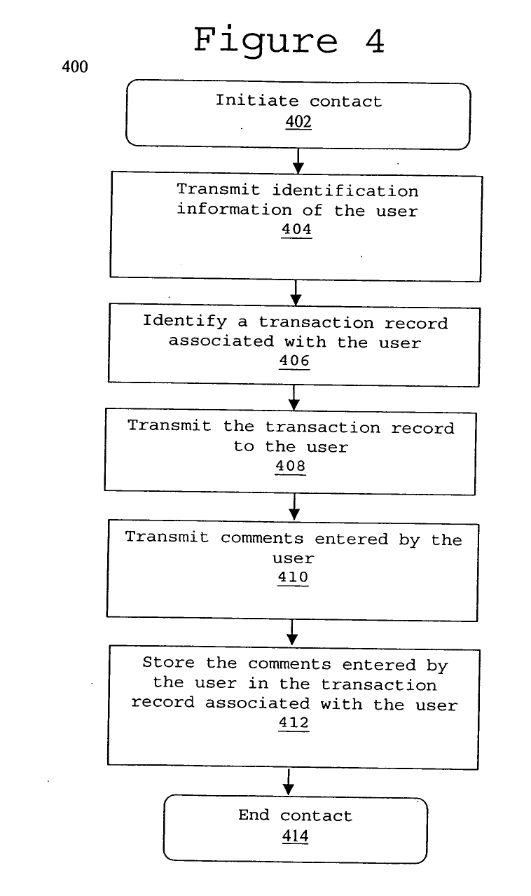

A flow chart illustrating a third exemplary embodiment 400 of the invention is shown in FIG. 4. The third exemplary embodiment 400 allows the user 110 to enter comments or make edits to a transaction record associated with the user 110. The method of the third exemplary embodiment 400 begins when the user 110 decides to initiate a communication to the communication center 102 (block 402). The user 110 transmits identification information of the user 110 to the communication center 102 (block 404). The communication management server 104 receives the identification information from the user 110 and identifies a transaction record associated with the user 110 (block 406). The communication management server 104 may transmit all or a portion of the information in the transaction record (block 408). The above aspects of the third exemplary are similar to the first exemplary embodiment 200 and are previously described in greater detail in the discussion of the first exemplary embodiment 200.

The third exemplary embodiment 400 allows the user 110 to enter and transmit additional information to include in the transaction record (block 410). The user 110 may be provided with a comment field to enter their version of the transaction. The user 110 enters the comments and the information is transmitted to the communication management server 104. The communication management server 104 may automatically store the comments entered into a field of the transaction record. The communication management server 104 may also transmit the comments or notify the agent assigned to the transaction record that the comments have been made. The system may allow the agent to enter additional comments in the transaction record in response or allow the agent to edit the comments previously entered by the user 110.

In the third exemplary embodiment 400, the user 110 may enter comments in a specific field of the transaction record. The method and system is not limited to a comment field for the user 110. The method and system may provide the user 110 with the ability to edit other fields of the record. For example, a user may be allowed to edit a field of the record that includes communication information, for example, home address, email address, phone number, or preferred method of communication.

The exemplary embodiments described herein are associated with the processor and memory associated with the communication management server. However, the aspects described in the exemplary embodiments may be implemented in a variety of digital electronic circuitry, or in computer hardware, firmware, software, or in combinations of them. The exemplary embodiments described herein can be implemented as a computer program product, i.e., a computer program tangibly embodied in an information carrier, e.g., in a machine-readable storage device or in a propagated signal, for execution by, or to control the operation of, a communications processing apparatus, e.g., a processing device, a computer, or multiple computers. A computer program can be written in any form of programming language, including compiled, assembled, or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

The present invention is not intended to be limited to a device or method which must satisfy one or more of any stated or implied object or feature of the invention and is not limited to the exemplary embodiments described herein. Modifications and substitutions by one of ordinary skill in the art are considered to be within the scope of the present invention.

The invention claimed is:

1. A method for providing communications between a communication center and a user comprising:
transmitting identification information of the user from a communication device of the user to the communication center;
identifying a transaction record associated with the user;
transmitting at least a portion of the transaction record of the user to the user;
transmitting current status information for a plurality of queues to the user; and
presenting to the user at least a portion of the transaction record of the user and the current status information for a plurality of queues.

2. The method of claim 1, further comprising:
transmitting one or more prior queue status information.

3. The method of claim 1, wherein current status information includes the number of agents assigned to each queue.

4. The method of claim 1, wherein the prior queue status information includes average wait times throughout the previous day.

5. The method of claim 1, further comprising:
providing the user with links to one or more modes of communication.

6. The method of claim 1, further comprising:
transmitting current transactions of the user.

7. The method of claim 6, wherein the current transactions include comments entered by the agent.

8. The method of claim 7, further comprising:
transmitting comments entered by the user to the agent and
storing the comments entered by the user in the transaction record associated with the user.

9. The method of claim 1, wherein the plurality of queues are for different modes of communication.

10. A system for providing a user interface for a user of a communication center comprising:
a database for storing one or more transaction records associated with the user;
one or more queues for storing communications prior to sending the communication to an agent;
a processor for receiving identification information of the user, searching the database for one or more transaction records associated with the user, and determining current status information for each of the one or more queues;
a network connection for transmitting at least a portion of the transaction record and the current status information to a communication device of the user and causing the communication device to display at least a portion of the transaction record and the current status information on the user interface.

11. The system of claim 10, further comprising:
the processor determining prior queue status information and the network connection for transmitting one or more prior queue status information and causing the communication device to display the one or more prior queue status information.

12. The method of claim 10, further comprising:
the network connection providing the user with links to one or more modes of communicating with the agent.

13. The method of claim 10, further comprising:
the processor determining current transactions and the network connection for transmitting the current transactions for display on the communication device.

14. The method of claim 10, further comprising:
the network connection transmitting comments entered by the user from the communication device and the processor storing the comments in the transaction record associated with the user.

15. A computer program product, tangibly embodied in an information carrier, for assigning a process to a processor for execution, the computer program product being operable to cause a machine to:
transmit identification information of the user from a communication device of the user to the communication center;
identify a transaction record associated with the user stored in memory;
transmit the transaction record of the user to the communication device;
determine the current status information for a plurality of queues;
transmit the current status information for a plurality of queues; and
display the transaction record of the user and the current status information for a plurality of queues to the user.

16. The computer program product of claim 15, further comprising the computer program product being operable to cause a machine to:
determine one or more prior queue status and
transmit the one or more prior queue status to the communication device.

17. The computer program product of claim 15, further comprising the computer program product being operable to cause a machine to:
provide the user with links to one or more modes of communication.

18. The computer program product of claim 15, further comprising the computer program product being operable to cause a machine to:
determine one or more current transactions for the user and
transmit the one or more current transactions of the user.

19. The computer program product of claim 18, wherein the current transactions include comments entered by the agent.

20. The computer program product of claim 15, further comprising the computer program product being operable to cause a machine to:
transmit comments entered by the user to the agent and
store the comments entered by the user in the transaction record associated with the user.
